(19) United States
(12) Patent Application Publication
(10) Pub. No.: US 2015/0066184 A1
(43) Pub. Date: Mar. 5, 2015

(54) PROCESS FOR OPTIMIZATION

(71) Applicant: Jemison-Demsey, LLC, Birmingham, AL (US)

(72) Inventors: Matt Bradford, Birmingham, AL (US); Pete Heinke, Birmingham, AL (US); Craig Wyatt, Atlanta, GA (US)

(21) Appl. No.: 14/318,243

(22) Filed: Jun. 27, 2014

Related U.S. Application Data
(60) Provisional application No. 61/840,262, filed on Jun. 27, 2013.

(51) Int. Cl. G05B 19/418

(52) U.S. Cl. CPC G05B 19/41865
USPC 700/106

(57) ABSTRACT

The present disclosure provides a method for optimization of a supply chain. In one embodiment, the optimization is accomplished by minimizing the cost of a raw material used by a manufacturer in the supply chain, through the identification of optimal specifications for the required raw material, through the identification of an optimal vendor from which to purchase the raw material given the optimal specification or a combination of the foregoing.

### FIELD OF THE DISCLOSURE

The present disclosure relates to a process for optimization of a supply chain. The present disclosure relates for specifically to a method for optimization of a supply chain by providing the optimal specifications for a raw material consumed in the supply chain and/or an optimal vendor for provision of the raw material conforming to the optimal specifications.

### BACKGROUND

All industries consume one or more raw materials in the manufacture of products. For example, a manufacturer of paper goods consumes rolls of raw paper for use in production of the finished good. Likewise, a manufacturer of parts for use in assembling automobiles may utilize steel (either in sheet form or roll form) as raw material to cut or stamp the required parts. Still further, a manufacture of part for use in assembling airplanes may use aluminum alloy (either in sheet or roll form) as raw material to cut or stamp the required parts. As such, these industries consume large quantities of raw materials. Therefore, there is a need in the art to maximize the use of these resources in order to maximize profit and produce the finished goods at the lowest price.

The present disclosure provides a method to minimize the cost of a raw material (for example steel) used by a manufacturer in the supply chain.

### BRIEF DESCRIPTION OF THE DRAWINGS

FIG. 1 shows one embodiment of a plot reported.

FIG. 2A shows one embodiment of a risk analysis graph comparing an exemplary current manufacturing process utilizing 3 different sizes of stock to an optimized specification specifying the same number of stock sizes but altering the dimensions.

FIG. 2B shows one embodiment of a risk analysis graph comparing an exemplary current manufacturing process utilizing 3 different sizes of stock to an optimized specification specifying two sizes of stock.

FIG. 3A shows one embodiment of a stress testing analysis based on a current supply situation.

FIG. 3B shows one embodiment of a stress testing analysis based on an optimized specification specifying three stock sizes.

FIG. 3C shows one embodiment of a stress testing analysis based on an optimized specification specifying two stock sizes.

### DETAILED DESCRIPTION

In a general embodiment of the method, the present disclosure provides a process for optimization of a supply chain. In a further general embodiment, the present disclosure relates specifically to a method for optimization of a supply chain by providing the optimal specifications for a raw material consumed in the supply chain and/or identifying an optimal vendor for provision of the raw material conforming to the optimal specifications. Through the provision of the optimal specification(s) (sometimes referred to herein as the optimal solution) described herein, cost to the client in obtaining the raw materials consumed in the supply chain is minimized, at least when compared to the current supply. In one embodiment, the cost is minimized by reducing the scrap of the raw material resulting from the manufacturing process. In another embodiment, the cost is minimized by optimizing a factor unrelated to reducing scrap, such as, but not limited to, providing an optimal specification that allows the raw material to be purchased at the lowest price or the like.

As discussed in the background section above, all industries consume one or more raw materials in the manufacture of products. For example, a manufacturer that produces products from a given raw material purchases the raw material for use in the production process. In many cases, the manufacturer purchases the raw material from a third party service provider, where the third party service provider itself purchases the raw material from one or more vendors of the raw material. The third party service provider generally purchases large quantities of the raw material in the desired from to ensure a continuous supply to the manufacturer. The manufacturer may also purchase the raw material directly from a vendor. When a third party service provider is involved, the third party service provider purchases the raw material from a vendor, optionally processes the raw material to the manufacturer's specifications (for example, by providing the raw material in a desired length and/or width) and ships the raw material to the manufacturer. The manufacturer then produces one or more parts and/or products from the raw material.

In most cases, the manufacturer provides the specifications for the raw material required (such as length, width, thickness or other characteristic of the required raw material). While the manufacturer may have taken steps to attempt to maximize the supply chain by minimizing the raw material leftover after use (referred to as scrap) and/or to minimizing the number of different sizes of raw material stock required in order to carry out its manufacturing operations, in most cases the solutions still result in excess waste of the raw material or an more sizes of the raw material stock than is required. For example, optimal specifications for the required raw material and/or optimal vendor from which to purchase the raw material may not be identified. These factors cause the manufacturer to spend more money in raw materials costs than may be required.

The remainder of the specification describes the teachings of the present disclosure in relation to the steel industry. However, the teachings of the present disclosure are equally applicable to the consumption of other raw materials. Exempalry raw materials include, but are not limited to, all types of metals, plastics and paper.

In the steel industry, a manufacturer that produces products manufactured from steel generally uses the steel in sheet or roll form (the steel, whether in sheet or roll form is sometimes referred to herein as “stock”). In most cases, the client purchases the steel stock from a third party service provider, where the third party service provider itself purchases the steel stock from a production mill (i.e, a vendor). The third party service provider generally purchases large quantities of the steel stock in the desired form to ensure a continuous supply to the manufacturer. The manufacturer may also purchase the steel stock directly from a production mill. When a third party service provider is involved, the third party service provider purchases the steel stock from the production mills, process the steel stock to the manufacturer's specifications (for example, by cutting steel plates or coil to a desired length and/or width) and ships the processed steel stock or unprocessed steel stock to the manufacturer. The manufacturer then produces the various parts and or products from the steel stock provided by the third party service provider.

In most cases, the manufacturer provides the specifications for the steel stock required (such as length, width, thickness and other characteristics of the steel sheet of roll). While the manufacturer may have taken steps to attempt to maximize the supply chain by minimizing the steel scrap and taken other steps to streamline the supply chain, in most cases the solutions are not optimal. For example, optimal specifications for the required steel stock and/or optimal production mill from which to purchase the steel may not be identified. These factors cause the manufacturer to spend more money in raw materials costs than may be required.

The present disclosure provides a method for optimization of a supply chain. In one embodiment, the optimization is accomplished by minimizing the cost of a raw material (for example steel) used by a manufacturer in the supply chain. In one embodiment, the optimization of the supply chain is achieved through the identification of optimal specifications for the required raw material. In another embodiment, the optimization of the supply chain is achieved through the identification of an optimal vendor from which to purchase the raw material given the optimal specification. In yet another embodiment, the optimization of the supply chain is achieved through minimizing the number of different forms (for example sizes or configurations) of raw material stock required for the manufacturer to carry out its manufacturing operations. In still a further embodiment, the optimization of the supply chain is achieved through a combination of the foregoing.

### Method Overview

In one embodiment, the method in its most general form comprises the following steps: (i) a data analysis step; and (ii) an optimization step. The process may further comprise at least one of the following steps (a) a data gathering step; (b) establishment of a baseline usage rate; (c) a risk analysis step; (d) a stress simulation test; and (e) a cost optimization step. Each of these steps is described in more detail below. The data analysis step generally analyzes a data set, which may be provided by the manufacturer who is seeking optimization of the supply chain (referred to herein as the “client”) or generated prior to the data analysis step through data obtained by the client, a party other than the client or a combination of the foregoing. In one embodiment the data analysis determines basis parameters about the quantities of raw material that will be used and may generate a set of potential specifications for the raw material so as to optimize the supply chain (for example, minimizing the costs to the client in utilizing the raw material). The optimization step generates one or more optimal specifications for the raw material so as to minimize the costs to the client in utilizing the raw material. As used herein, the term “optimal specification” means that the specification for the raw material is at least superior to the specification currently used to use and/or obtain the raw material; the term does not mean that the specification for the raw material generated is the absolute best. As discussed herein, more than one optimal specification may be generated from a single set of data.

In a more particular embodiment, the method comprises the following steps: (i) an optional data gathering step; (ii) a data analysis step; and (iii) an optimization step. In one aspect of this embodiment, the data gathering step, when used, utilizes, at least in part, data provided by the client. In another aspect of this embodiment, the data gathering step utilizes data provided by the client and data collected from third parties, such as a supplier of a raw material.

In a more particular embodiment, the method comprises the following steps: (i) an optional data gathering step; (ii) a data analysis step; (iii) an optional establishment of a baseline usage rate; and (iv) an optimization step. In one aspect of this embodiment, the establishment of a baseline usage rate is calculated in the data analysis step. In another aspect of this embodiment, the baseline usage rate is provided by the client. In still another aspect of this embodiment, an initial baseline usage rate is provided by the client and an additional baseline usage rate is calculated in the data analysis step. The baseline usage rate may include the total amount of a given raw material used in a particular process as well as other information such as the amount of material that is considered scrap material. The baseline usage rate may be compared to a final usage rate determined after the optimization step.

In a further more particular embodiment, the method comprises the following steps: (i) an optional data gathering step; (ii) a data analysis step; (iii) an optional establishment of a baseline usage rate from the gathered data; (iv) an optimization step; and (v) a cost optimization step. In the cost optimization step, the optimal specification generated by the data analysis step if analyzed further to determine an impact, if any, on supplier constraints related to the optimal specification of the raw material. For example, is there an up-charge/additional cost involved in purchasing or shipping the raw material that conforms to the optimal specification?

In yet a further more particular embodiment, the method comprises the following steps: (i) an optional data gathering step; (ii) a data analysis step; (iii) an optional establishment of a baseline usage rate from the gathered data; (iv) an optimization step; a (v) a risk analysis test or a stress test; and (vi) a cost optimization step. In still a further more particular embodiment, the method comprises at least five of the following steps: (i) an optional data gathering step; (ii) a data analysis step; (iii) an optional establishment of a baseline usage rate from the gathered data; (iv) an optimization step; a (v) a risk analysis test; and (vi) a cost optimization step. In still a further more particular embodiment, the method comprises the following steps: (i) an optional data gathering step; (ii) a data analysis step; (iii) an optional establishment of a baseline usage rate from the gathered data; (iv) an optimization step; a (v) a stress test or a risk analysis test; and (vi) a cost optimization step. The purpose of the risk analysis step and the stress test is to subject the optimal specification to a variety of real-world factors to test the robustness of the optimal specification.

In still a further more particular embodiment, the method comprises the following steps: (i) an optional data gathering step; (ii) a data analysis step; (iii) the establishment of a baseline usage rate from the gathered data; (iv) an optimization step; a (v) a risk analysis test; (vi) a stress test; and (vii) a cost optimization step.

Each of the steps of the method is discussed in more detail below. As is evident from the foregoing description, not every step disclosed is required in every embodiment of the method disclosed.

### Data Gathering

The data gathering step comprises obtaining information about the supply chain. Such data may be gathered or provided by the client who is seeking optimization of the supply chain about the supply chain or a party other than the client. In one aspect, the data gathering step utilizes data provided by the client. In another aspect, the data gathering step utilizes data provided by a third party, such as a supplier of a raw material or a third party service provider. In yet another aspect of this embodiment, the data gathering step utilizes data provided by the client and data provided from third parties or a third party service provider. As discussed above, the data gathering step is an optional step in certain embodiments of the methods disclosed.

Such data may include, but is not limited to, information about the parts to be manufactured, information regarding the manner in which the parts are produced, information regarding the steel currently used in the manufacturing process and information concerning the equipment to be used by the client to manufacture the parts.

Relevant information about the steel currently used in the manufacturing process includes, but is not limited to, pricing of the steel, the form (for example size) of the steel used, the length of the steel, the width of the steel, the thickness of the steel, whether plates are coil are utilized, any coatings or other treatments required, the number of steel stocks currently used, the tensile strength of the steel and other physical properties of the steel. Relevant information about the parts to be manufactured includes, but is not limited to, the scrap rate, the dimensions of each part to be manufactured, the number of each part to be manufactured (such as on an time basis, for example parts per month or parts per year), the weight of each part to be manufactured, information about required spacing between various parts, current mapping of the parts onto steel sheets/coil, whether rotation of a part is allowed on the sheet and whether any two parts may share a common cut line. Relevant information about the manner in which the parts are produced includes, but is not limited to, whether the parts are stamped from the steel or whether the parts are cut from the steel (such as by plasma cutting, laser cutting fuel flame cutting and the like). Such information is relevant as it determines, at least in part, spacing between the parts that may be required. Relevant information concerning the equipment to be used by the client includes, but is not limited to, the maximum/minimum width and/or length the equipment can utilize and the amount of trim distance required for a particular piece of equipment used to cut the parts. Other information may be gathered as would be known in the art.

The various data are loaded into a database for analysis. As discussed herein, a variety of databases may be used. In one embodiment, a relational database is used as is known in the art. Such a relational database allows for efficient search and utilization of the information.

### Data Analysis

The data analysis step generally analyzes a data set, which may be the data set gathered as discussed above, to determine basic parameters about the raw material that will be used, such as, but not limited to, the quantity, and other information. The data analysis step may generate a set of preliminary optimal specifications for the steel sheets/rolls so as to minimize the costs to the client in utilizing the raw material.

In one embodiment, the data is initially analyzed to create a report. The report can take on a number of formats and provide a wide range of information. In one embodiment, the report determines patterns in usage of the parts to be manufactured from the steel and indentifies possible lengths and or width that may be candidate stock sizes for a particular piece.

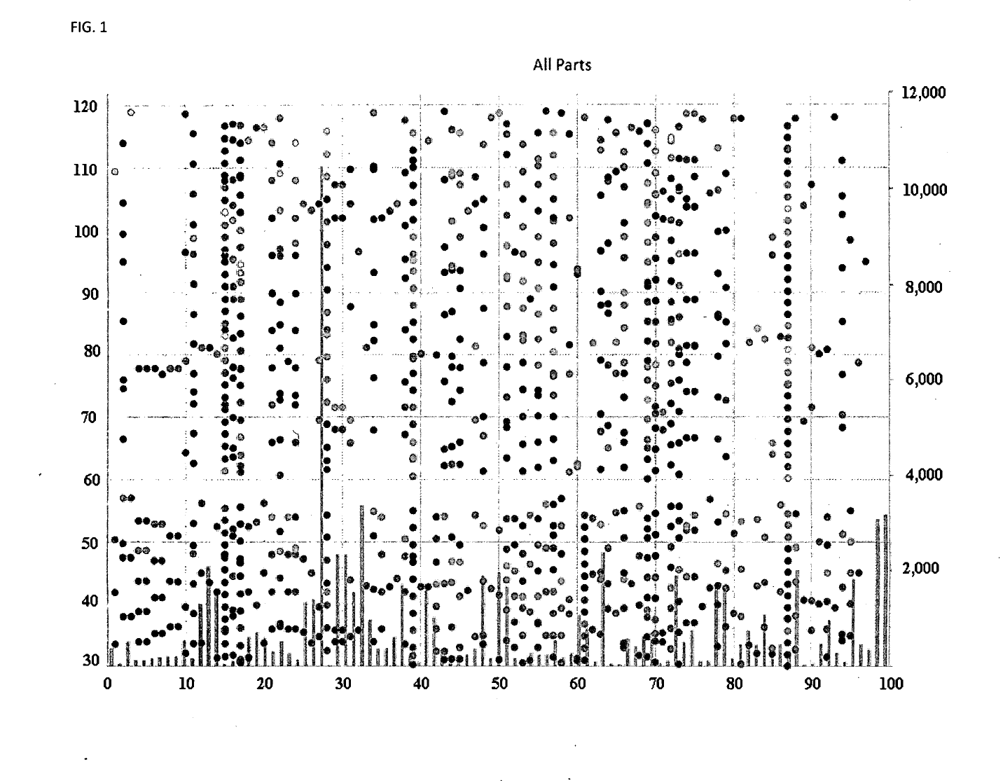

In one embodiment, a plot report is created. The plot report takes every part to be manufactured from the steel (for example, as entered in a database) and determines how many pound of steel will be required for each part (for example, by multiplying the actual or calculated weight of a single piece by the number of pieces to be produced) and generates a series of preferred widths and/or lengths of steel that are good candidates for the production of each part based on the dimensions of the part (based on for example, the dimensions of the pieces as entered into a database). In one embodiment, the preferred lengths and/or widths are generated as follows. A minimum and maximum length and width for the stock size is determined. The determination may be based on a range around the stock sizes currently used, may be determined arbitrarily or may be determined based on a range around a size of stock that is desired to be used due to costs or manufacturing considerations. Once the minimum and maximum widths are determined, the number of parts, based on the dimensions of the part input into the database as described above, that can fit exactly into a width or length in the range are determined. For example, if the minimum/maximum width is 30/60 inches, the minimum/maximum length is 60/120 inches, the range of potential lengths and width spans 30 to 120 inches. If two parts are considered having dimensions of 3×3 and 10×10 inches, the number of times each part can fit, in one embodiment exactly fit, into a distance in the range is calculated. For the 3×3 part, the part fits into the lower range of 30 inches 10 times and the upper range of 120 inches 40 times; overall 31 dimensions in the range of 30 to 120 inches can accommodate the part. For the 10×10 part, the part fits into the lower range of 30 inches 3 times and the upper range of 120 inches 12 times; overall 10 dimensions in the range of 30 to 120 inches can accommodate the part. In a plot of data such as shown in FIG. 1, part 1 would be represented by 31 dots starting at 30 inches and proceeding in 30 increments of 3 until 120 inches and part 2 would be represented by 10 dots starting at 30 inches and proceeding in 9 increments of 10 until 120 inches. Other methods may also be used to accomplish the foregoing.

An exemplary plot report is shown in FIG. 1. The X-axis lists parts numbers, in this case from 1 to 124. The Y-axis provides total pounds for each part (right side) and lengths and/or width (in inches, left side). The dots positioned vertically above each part represent potential optimal specifications in terms of length and/or width (the color of the dots in FIG. 1 is arbitrary) while the bars represent the usage in pounds for each part. The plot report provides a visual representation of the parts to be manufactured in terms of pounds of steel required for each part and also in terms of potential lengths and width of the steel stock that may be used to produce each part. One purpose of the plot report is to identify patterns in the parts usage in order to identify one or more preferred lengths and/or widths of the steel to be supplied to the manufacturer. In some cases, a part with a heavy usage or a part that requires the greatest amount of steel (in pounds or area) is used to aid in reaching a solution.

In some cases a pattern may be seen visually. In other cases, an algorithm or other function is applied to the data to identify a pattern. Regardless of the method used to determine the pattern, the pattern observed may suggest one or more preferred lengths and/or widths of the steel to be supplied to the manufacturer. In one embodiment, an algorithm or other mathematical function is used to identify a pattern. A number of such algorithms or functions may be used. In one aspect of this embodiment, the algorithm is a kMeans grouping. The kMeans function is a known algorithm that measures the distance between points on a plot and defines an arbitrary line, or lines, in order to create logical groups. The number of arbitrary lines may be set by the user; visual inspection of the graph may be used to determine the number of arbitrary lines used. For example, if three arbitrary lines are chosen, the data will be grouped into three sets, resulting in the identification of three sizes of steel that may be used to manufacture the parts.

When a pattern is observed, the preferred lengths and/or widths may be used as a starting point in the optimization procedure described below. In certain cases a pattern suggestive of preferred lengths and/or widths will not be visible. In such circumstances, the preferred lengths and/or widths may be obtained from the optimization step described below.

As a part of the data analysis step, a baseline parameter may also be established. In one embodiment, the current usage parameters provided by the client (for example, the lengths and widths of the steel stock currently used and the current placement of the parts on the stock) are used to determine such a baseline parameter. The baseline parameter may be provided by the client as well without a data analysis step being required.

In one embodiment, the baseline parameter is the current scrap rate (which may be referred to as the baseline scrap rate). In order to determine the current scrap rate, the parts are nested onto the steel stock currently used by the client. The nesting operation may utilize the placement of the parts as currently used by the client. Alternatively, the current scrap rate may be provided by the client. Regardless of the baseline parameter used, the corresponding parameter is determined with respect to one or more optimal specifications to monitor an improvement over the current conditions.

### Optimization

The optimization step generates one or more optimal specifications (i.e., identifying one or more preferred lengths and/or widths of the steel stock to be supplied to the client) so as to minimize the costs to the client in utilizing the stock. A single optimal specification may be generated or multiple optimal specifications may be generated. For example, multiple optimal specifications may be generated based on a client's desire to minimize the number of steel stock sizes required to be used. In such a scenario, an optimal specification may be generated for 2 different sizes of steel stock, 3 different sizes of steel stock and so on in order to examine the benefit of different configurations.

In generating the optimal specification, a number of engines may be employed. The various engines include, but are not limited to: (i) a single sheet option; (ii) a multi-sheet option based on the largest pounds used or largest area used; (iii) a kMeans option; (iv) a multi-sheet brute force option; and a (v) length only option.

Before describing each engine, the various engines may call several algorithms/mathematical functions to accomplish their task. Such algorithms/mathematical functions include, but are not limited to, a NEST algorithm and a COMBO algorithm.

The NEST algorithm places the parts on the stock (which as discussed herein may be a sheet, roll or other form) in a defined manner. In one embodiment, the stock dimensions (length and/or width) are input by the user prior to running the NEST algorithm. In one embodiment, a single stock dimension is input into the algorithm at a time and a solution returned for that algorithm. The parts may be placed on the stock in a static manner (meaning a single part or a series of parts that are used together are placed as many times as possible on a given stock given the constraints of the data provided (i.e., part size, X/Y spacing and the like) or a dynamic manner (parts are mixed together to place as many parts on a stock piece as possible given the constraints of the data provided (i.e., part size, X/Y spacing and the like). Regardless of the static or dynamic manner, the algorithm may take one of several approaches in placing the parts on a given piece of stock. Such approaches include, but are not limited to, (a) positioning a given part against the short side of a free stock piece space into which the part fits best; (b) positioning a given part against the long side of a free stock piece space into which the part fits best; (c) positioning a given part into the smallest free stock piece space into which the part fits; (d) a tetris placement which places parts on the bottom left open stock piece space in the best manner possible until the space is filled; and (e) a placement where a given part touches other parts as much as possible. The NEST algorithm runs thousands upon thousands of simulations to determine the a preferred placement of parts, returns possible X/Y coordinates for the parts on a given stock size and provides estimated scrap rates for the given steel stock size. The process is repeated for additional stock sizes and the results are compared to identify the optimal stock size.

In another embodiment of the NEST algorithm, referred to as Static NEST, only applies to the static nesting method using a single part per piece of stock. In this application of the NEST algorithm, the dimensions of the stock (length and/or width) are input prior to running the Static NEST algorithm. In one embodiment, a single stock dimension is input into the algorithm at a time and a solution returned for that algorithm. In addition, the dimensions of the part (for example, length, width and other measurements) to be placed on the stock, the spacing required between the parts and a Boolean flag for possible rotation are input prior to running the Static NEST algorithm. In one embodiment, the part dimension X is divided into the dimension X of the stock piece being evaluated. The remainder of the X dimension is calculated, such as using a modulo function. The potential for the part X to fit into the calculated remainder is checked. If the part can be placed in the calculated remainder, it is placed and the process is repeated until the condition is no longer true. The same set of calculations is determined for the y axis dimensions. The result of the calculation provides the number of parts that can be placed on the stock piece and allows the calculation of a scrap percentage. In contrast to the NEST function described above, the exact placement of the parts is not determined, only the number of parts that can be placed on the stock piece. Since the actual placement coordinates are not calculated, the required calculations may be completed in a shorter amount of time as compared to the NEST function described in the preceding paragraph. The process is repeated for additional stock sizes and the results are compared to identify the optimal stock size.

The COMBO algorithm accepts a number of possible widths, lengths, sheet numbers and parts list as well as a nesting strategy (static or dynamic). An array of stock sizes is created using the input of all possible widths and lengths (the possible lengths and widths may be selected by the user or be a result of an engine operation described below) as well as the maximum number of sheet sizes allowed (as determined by the user). The COMBO algorithm uses multiple threads to loop through all combinations of solutions and uses the NEST algorithm to place the parts on the stock. An array of the master lengths and widths with the lowest scrap rate is returned.

### Engines

The present disclosure may use a number of engines for determining the preferred dimensions of the stock. A number of such engines are known in the art and may be used with the teachings of the present disclosure.

In a general embodiment, the various engines include, but are not limited to: (i) a single sheet option; (ii) a multi-sheet option based on the largest pounds used or largest area; (iii) a kMeans option; (iv) a multi-sheet brute force option; and a (v) length only option.

In a particular embodiment, a single sheet engine is used. For the single sheet option, a maximum/minimum length and a maximum/minimum width are provided by the user. The maximum and minimum lengths and widths may be determined from the initial plot described above, by constraints required by the manufacturer due to its equipment or a variety of other factors. The maximum/minimum width and length are varied by a given increment (for example 0.1 inches) to produce an array of stock sizes. The parts are then placed on the stock for each stock size in the array. In one embodiment, the NEST algorithm is run on each stock size in the array. In one embodiment, scrap rates for each stock size in the array are tracked and the size that provides the lowest scrap rate is selected.

In a particular embodiment, a multi-sheet engine is used. In one embodiment of the multi-sheet option, the various lengths and/or widths are constrained based on a characteristic of a particular part. In one embodiment, the characteristic of a part may be based on the part that requires the largest poundage for production. In another embodiment, the characteristic of a part may be based on the part that requires the largest area. In many cases, the same part will satisfy both criteria. The dimensions of the starting stock are chosen initially to be the best match for the part with the largest pound usage or largest area. A maximum/minimum length and a maximum/minimum width are provided by the user. The NEST algorithm is used to place additional parts on the selected stock sheet provided the additional parts result in a scrap rate under a set percentage as chose by the user. The parts identified in this iteration that will nest onto the selected stock sheet are removed from the list of parts and the process is repeated using a remaining part that has the largest pound usage or area. The process is repeated until no parts remain. The result is a list of lengths and widths that are candidates for optimal sizes (for example, 5 different widths and lengths may be returned). All combinations of the selected widths and lengths are selected. For the example with 5 widths and lengths, 25 potential stock sizes are generated. The number of distinct stock sizes desired may be input by a user (for example, 2, 3 or 4 distinct sizes) and the COMBO algorithm loops through all possibilities using the NEST algorithm and selects the combination of stock sizes with the lowest scrap rate. For the 5 length/width example, a 2 stock dimension solution will generate 300 possibilities, a 3 stock dimension solution 2300 possibilities and a 4 stock dimension solution around 12,500 possibilities.

In a particular embodiment, a kMeans engine is used. The kMeans function is as described and serves to identify potential widths/lengths that are suitable. In order to execute the kMeans engine, all possible length and width combinations are provided. This data may be obtained from the plot described above and shown in FIG. 1. The kMeans function is a known algorithm that measures the distance between points on a plot and defines an arbitrary line, or lines, in order to create logical groups. The number of arbitrary lines (groupings) may be set by the user (for example, how many stock sizes are desired or on other factors). Visual inspection of the plot may be used to determine the number of arbitrary lines (groupings) used. For example, if three arbitrary lines are chosen, the data will be grouped into three sets, resulting in the identification of three dimensions of stock of that may be used to manufacture the parts. After the potential dimensions of the stock are identified, the array identified is process through the COMBO algorithm or an engine described above to determine the best stock dimensions.

In a particular embodiment, a multi-sheet brute force engine is used. In the multi-sheet brute force approach is used, the process is carried out as described with the single engine option, with the difference being that multiple sheets are input into the problem and the problems are solved simultaneously. In one embodiment, the solution is limited to a two pieces of stock.

In a particular embodiment, a static width engine is used. The static width solution operates like the single sheet solution described above, except that only the length is varied. The width is input by the user. The maximum and minimum lengths may be determined from the initial plot described above, by constraints required by the manufacturer due to its equipment or a variety of other factors. The length is varied by a given increment (for example 0.1 inches) within the maximum/minimum range to produce an array of stock sizes (in this case, each stock size having a set width). The parts are then placed on the stock for each stock size in the array. In one embodiment, the NEST algorithm is run on each stock size in the array. Scrap rates for each stock size in the array are tracked and the size that provides the lowest scrap rate is selected.

In summary, the overall concept is to identify an optimal dimension(s) (for example, length and/or width) of stock that is optimal for use based on the data provided. In one embodiment, the optimal dimension(s) are determined by determining the dimension(s) with the lowest scrap rate.

### Risk Analysis

The optimization step discussed above provides an optimal specification for a particular client based on the clients requirements through the provision of an optimal dimension (for example length and/or width) for stock from which to manufacture parts and/or products. The optimal specification may be subject to additional analysis to validate the solution against various contingencies, such as shifting usage of the parts manufactured from the stock.

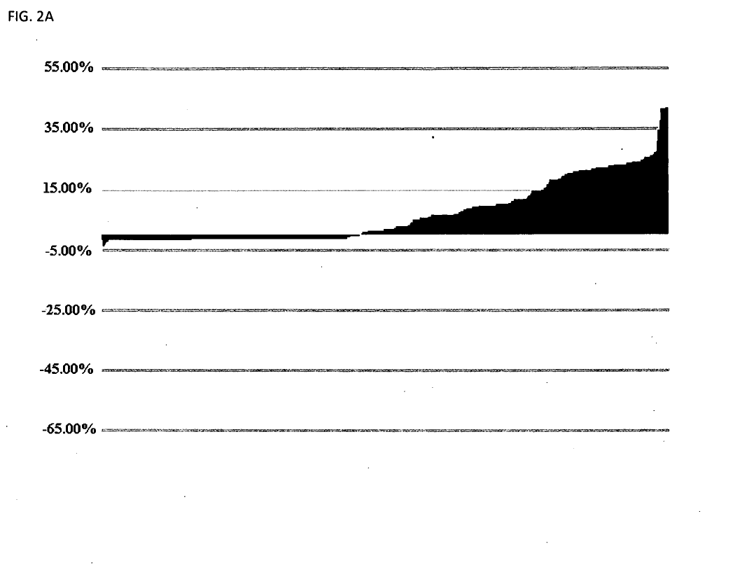

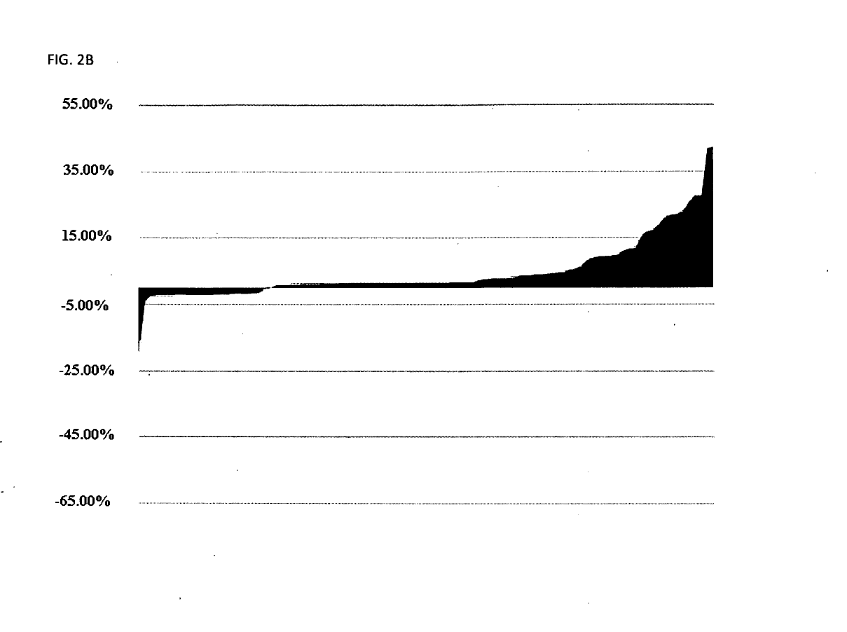

In one embodiment, this additional analysis is risk analysis. The risk analysis compares the proposed optimal specification(s) versus the current manufacturing scheme to assess the risk associated in a shift in usage of one or more parts. While the method described above generates an optimal specification that is superior for the totality of the parts manufactured, the solution will not superior, at least as compared to the current manufacturing process, for all parts. In this analysis, the scrap rates are determined for each part manufactured under the generated optimal specification as well as the current manufacturing process and the scrap rates are compared. In one embodiment, those parts manufactured with positive, negative or neutral (around zero) scrap rates as compared to the current manufacturing process are identified. For example, a part that has a 15% positive scrap rate indicates that as compared to the current manufacturing process, that part under the optimal specification identified by the methods described herein has a scrap rate that is 15% better than the current manufacturing process. This analysis identifies parts that due to a shift is usage, could alter the utility of the proposed optimal specification. The results may be provided visually, such as in the form of a plot or graph if desired. An exemplary risk analysis plot is provided in FIGS. 2A and 2B. In this figure, the X axis represents the individual parts and the Y axis represents the scrap rate for the optimal specification versus the current supply.

The results presented in FIGS. 2A and 2B represent an actual commercial simulation, with FIG. 2A showing the results from a comparison of an exemplary current manufacturing process utilizing 3 different sizes of stock to an optimized solution specifying the same number of stock sizes but altering the dimensions and FIG. 2B showing the results from a comparison of an exemplary current manufacturing process utilizing 3 different sizes of stock to an optimized solution specifying 2 sizes of stock. As can be seen in FIGS. 2A and 2B, a greater majority of parts exhibit a positive scrap rate. Furthermore, the magnitude of the positive scrap rate variance is in most cases greater than the negative scrap rate variance. This indicates that the odds of a random swing in usage will not likely impact the utility of the optimal specification. Furthermore, a comparison of FIGS. 2A and 2B indicate that simplifying the supply chain from 3 stock sizes to 2 stock sizes will not significantly impact the risk analysis. If the analysis indicates a perceived high risk that a random swing in usage will impact the utility of the optimal specification, the optimal specification may be rejected or modified by running the above steps for a second time, in this case eliminating the optimal specification identified in the first iteration.

In one embodiment of this method, the risk analysis step comprises determining a scrap rate for each part manufactured using the generated optimal specification, determining the scrap rate for each part manufactured under the current manufacturing process and comparing the scrap rate for each part manufactured using the generated optimal specification to the scrap rate for each part manufactured under the current manufacturing process to identify one or more parts that have a positive, negative or neutral scrap rates as compared to the current manufacturing process.

In addition to addressing the risk in usage swing, the plot discussed above can also be used to identify particular parts that have a negative scrap rate, particular a negative scrap rate with a large negative scrap rate variance, for monitoring. If a part with a negative scrap rate shows a usage rate that is greater than assumed when generating the optimal specification, the optimal specification may no longer be valid. In such a case, the process described above may be re-run using the new usage data to validate the original optimal specification generated or to arrive at a new optimal specification.

### Stress Testing

In one embodiment, the additional analysis is stress testing. Stress testing is an additional test that simulates swings in usage. In this analysis, each part is subject to different usage conditions to create a simulated usage range. In one embodiment, the simulated usage range has an upper and lower bound created on either side of the actual usage rate. In one embodiment, the usage rate is provided by the client. The usage rate may vary as determined by the user. An exemplary range for the usage rate for may be from 0 usage to 500% usage; other ranges, either narrower or broader may also be used. Once the range is established, a defined number of values within the range are randomly selected for each part, with the usage for the remaining parts being held constant at the usage rate. In one embodiment, 1-10, 1-50, 1-100, 1-1000 values, 1-250 values, 250-500 values or 500-1000 values with the range are selected for each part; depending on the range selected and number of values selected, a value within range may be used more than once. The optimal specification is evaluated for each randomly generated value and the scrap rates are determined. By doing so, potential volatility in the optimal specification is identified. The result may be analyzed for each part, a selected group of parts (such as those with the highest usage or highest pounds of steel required) or may be aggregated into an overall result for the totality of the parts. In addition, the stress testing analysis may be undertaken with the current manufacturing conditions as a comparison. In one embodiment, the simulation is accomplished using a Monte Carlo simulation. The results provided include the provision of an average scrap rate, the standard deviation, as well as the minimum and maximum scrap rates observed.

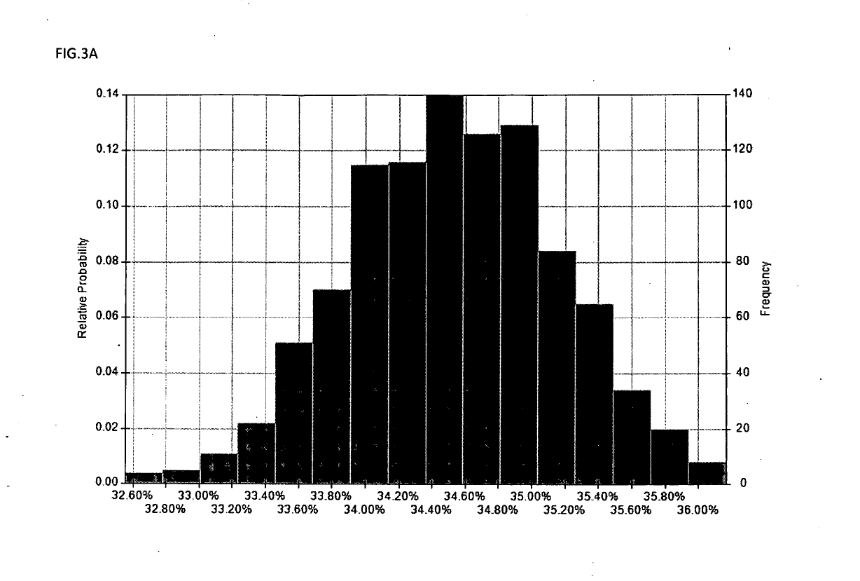

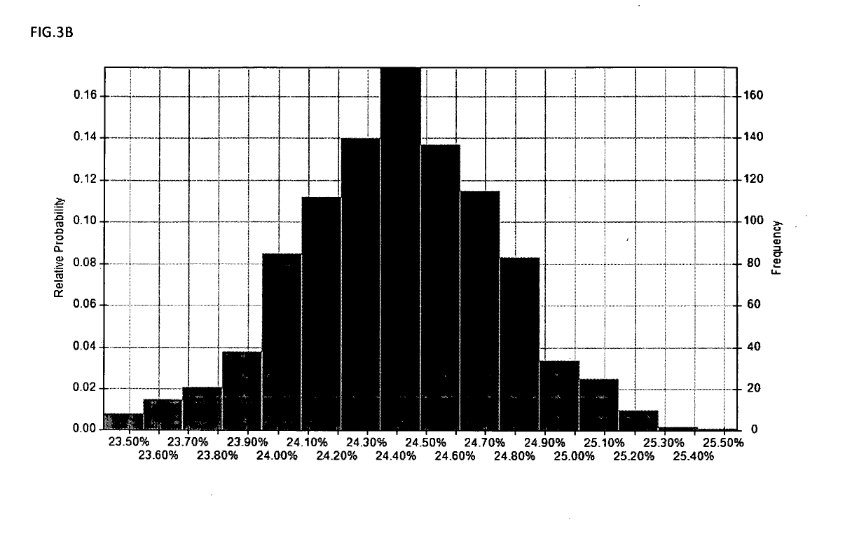

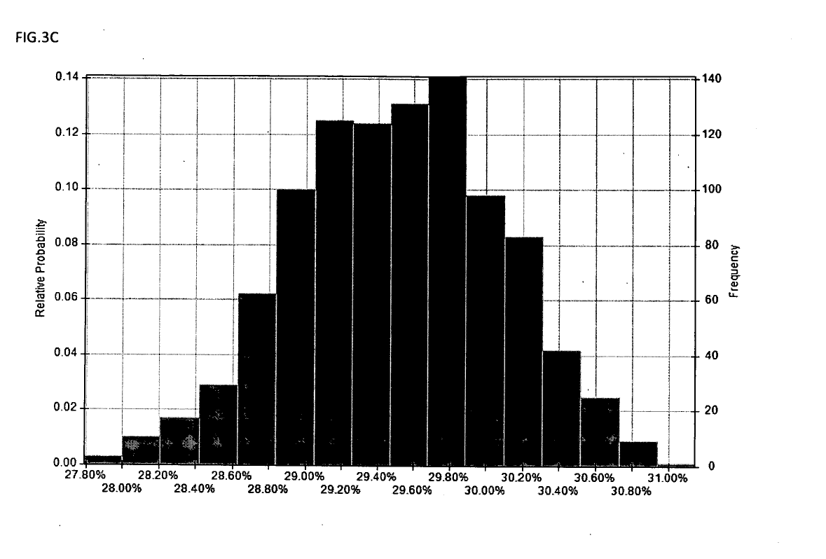

The results of stress testing may be presented in a graphical format, such as a graph or plot. An exemplary stress testing plot is shown in FIGS. 3A to 3C. In these figures, the X axis represents the scrap, rate of each solution and the Y axis represents the percentage of the scenarios that resulted in a given scrap rate. In these figures, data from all parts has been aggregated. The results presented represent an actual commercial simulation, with FIG. 3A being the results from an exemplary current manufacturing process utilizing 3 different sizes of stock, FIG. 3B being the results of an optimized process obtained by the methods described herein keeping the number of stock sizes the same but changing the dimensions of the stock sizes and FIG. 3C being the results of an optimized process obtained by the methods described herein where the number of stock sizes was decreased to 2. As can be seen in comparison of FIGS. 3A and 3B/3C the proposed optimal specification results in a significant decrease in overall scrap rate. Furthermore, as shown in FIGS. 3B and 3C, the simulated change in usage does not significantly change the overall scrap rate indicating the optimal specification identified is valid. Furthermore, the comparison of FIGS. 3B and 3C indicates that the optimized solution that decreases the number of stock size to 2 still results in a significant decrease in scrap rate while further simplifying the client's supply chain.

In one embodiment, the stress testing comprises varying the usage rate for a given part from the actual usage rate to create a simulated usage range, selecting a plurality of values within the simulated usage range, evaluating the scrap rate under the generated optimal specification and/or the current manufacturing process using each of the plurality of values within the simulated usage range to generate a simulated scrap rate. The simulated scrap rate may be presented for each part, for a subset of parts of for all parts subject to the analysis. The simulated scrap rate may be compared to the scrap rate determined under the optimal specification using the actual usage rate to predict volatility in the solution. Furthermore, the simulated scrap rate may be compared to the scrap rate generated from the actual usage rate using the optimal specification to generate a comparison scrap rate.

If the simulated scrap rate obtained using a generated optimal specification shows volatility (for example, the potential for large swings in the scrap rate based on a change in usage) as compared to the scrap rate calculated under the generated optimal specification using the actual usage rate, the generated optimal solution may be revised. In one embodiment, this process is completed for each part or for a selected number of parts (for example 25%, 50% or 75% or more) and the variations in scrap rates are presented, either individually for each part or as an aggregate for all parts. In one embodiment, an average scrap rate is presented aggregating the data from all parts subject to the analysis. If the simulated scrap rate is over a set amount, the solution may be reconfigured if desired. In one embodiment, the set amount may be the comparison scrap rate exceeding, such as 2 times, 3 times, or 5 times, the scrap rate observed under the current manufacturing process or the scrap rate determined under the optimal specification.

If the analysis indicates a perceived high risk that a swing in usage will impact the utility of the optimal specification, the optimal specification may be rejected or modified by running the above steps for a second time, in this case eliminating the optimal specification identified in the first iteration.

In addition to addressing the volatility in usage swing, the analysis discussed above can also be used to identify particular parts that have a negative impact on the optimal specification, for monitoring. If the identified part shows a usage rate that is greater than assumed when generating the optimal specification, the optimal specification may no longer be accomplishing the goal of minimizing cost to the client. In such a case, the process described above may be re-run using the new usage data to validate the original optimal specification generated or to arrive at a new optimal specification.

### Cost Model

In still another embodiment, this additional analysis is referred to as cost analysis. In this analysis, the optimal specification is subject to a cost model that identifies the actual costs to the client in utilizing the stock identified in the optimal specification. In some case, the optimal specification, while providing the lowest overall scrap rate, may not minimize costs to the client. For example, an identified optimal specification may specify a stock sheet of steel that is 50.7 inches in width by 120 inches in length. The next best optimal specification identified may specify a stock sheet of steel that is 47.8 inches in width by 115 inches in length. Assume that most production mills in the client's geographic area charge an additional fee of $3.00 per sheet of steel that is over 50 inches in width. Under this scenario, the best optimal specification (50.7 inches in width by 120 inches in length) while providing the lowest scrap rate may not minimize cost to the client, while the second best optimal specification (47.8 inches in width by 115 inches in length) although having a higher scrap rate will minimize overall cost to the client. The goal of the cost model is to identify such situations.

In one embodiment, one or more of the generated optimal specifications (for example, length and/or width of a stock piece) and quantities of stock required are input into a database or program that contains certain cost variables regarding the vendors, third party service providers, client and/or costs regarding the stock specified by the generated optimal specification. Such variables include, but are not limited, i) variables concerning the vendor/production mill from which the raw material conforming to the optimal specification is purchased; ii) variables concerning the third party service provider that purchases and/or further process the raw material purchased from the vendor/production mill; and iii) variables relating to the client (which may, in part, be the same information collected in the data gathering step discussed above). Exemplary variables falling into each category are provided in Tables 1-3.

Information corresponding to each variable is entered into a database. As an example of the information that corresponds to certain variables, in Table 1, one of the variables discussed is a cost variable, specifically as related to gauge and width. Information that may be entered for this variable includes, but is not limited to, any additional charge imposed by the vendor for producing a raw material over a certain width or over a certain gauge. As this variable may be different between vendors, information regarding this variable may point to a vendor able to deliver the raw material conforming to the optimal specification at the lowest price. Alternatively, this variable may suggest that an optimal specification identified may need to be reevaluated if all vendors impose an additional cost. Furthermore, one of the variables discussed in Table 1 is “gauge and width deviations”. Information that may be entered for this variable includes, and the length, width and/or gauge delivered. In many industries, including the steel industry, raw material costs are based on centum weight (CWT; price per hundred pounds). As a result, if the delivered raw material differs from the dimensions ordered, this “extra” material is essentially wasted since the optimal specification did not take the material into consideration in formulating the solution. Identifying vendors who consistently have over-variances in the length, width and/or gauge aids in the identification of a lowest cost vendor.

One of the variables discussed in Table 2 relates to information by machine type and includes items like number of operators, maximum dimensions being handled and the like. The information entered under these variables may be used to calculate the costs of the third party service provider to perform any required operations on the raw material prior to providing the same to the client. By taking these variables into consideration, the optimal specifications generated (for example a 3 sheet solution and a 2 sheet solution) may be compared to identify factors that would make one solution preferable to the other.

Additional variables may relate to the cost of processing the steel to the desired size by the third part service provider, labor costs for any additional work, machine costs for any additional work, cost of transport, cost of stocking required amounts of steel and administrative costs.

The output is a total costs for a proposed optimal specification, which may break out the various variables discussed above to determine how they impact the total costs. Such a calculation may be carried out for one or more generated optimal specifications and the generated optimal specification with the lowest overall cost identified. In certain cases a proposed solution that yields the best scrap percentage may not yield the lowest overall costs due to one or more variables described above. Using this information, the method described above can be re-initiated with an additional generated optimal specification where the variables (such a restriction on length and/or width) as identified by the cost model are varied.

In one embodiment, the cost analysis comprises inputting a first generated optimal specification into a database of cost factors to determine a first cost of the raw material specified by the first generated optimal specification, inputting a second generated optimal specification into a database of cost factors to determine a second cost of the raw material specified by the second generated optimal specification and optionally inputting an n^{th} additional generated optimal specification into the database of costs factors to determine an n^{th} cost. The cost analysis may further comprise comparing the first cost to the second cost and optionally the n^{th} costs to identify the generated optimal specification with the lowest overall costs.

In the foregoing, the generated optimal specifications may include the dimensions (length, width and/or thickness) of the raw material stock identified by the optimal specification. In the foregoing, the database may contain one or more of the variables identified in Tables 1-3.

TABLE 1
Variables Related to Vendors/Production Mills

```
Payment Terms
Freight information
  Mileage to Service center location
  Freight Rate (CWT)
  Truck & Rail Shipment
Information by Product (Hot Rolled, P&O, Cold Rolled, Galvanized)
  Capacity Information
      Min/Max
        Thickness
        Coil LBS
        ID (& Preferred ID)
      PIW—by coil width
      OD—by coil width
      Width
        Max Width, by thickness & yield strength
Cost Inputs
    Grade
    Gauge & Width
    Pickling (if applicable)
    Coating (if applicable)
    Edge Condition
    Order Item Qty
    Coil Size
    Other
      Group
      Extra Smooth
      Temper Pass
      Test Reports
Gauge & Width Deviations
    Collected by product/gauge
```

TABLE 2
Variables Related to Third Party Service Providers

```
Location Information
  Work days
  Hours per shift
  Shifts per day
  Hours open for production
  # of employees
    Traffic
    Maintenance
    Handlers
    Temps
Information by Machine
  # of Operators
  Usage Rate
  Run Rate
  Restock Minutes
  Maximum Dimensions Capable of Being Handled
    Width
    OD
    Weight
    Length
    Bundle height
  Recoiler Id
    Change minutes
  Width/Length tolerance
  Min Width
  Trim Scrap
    By Gauge Range
  Max Yield strength
    By Gauge Range
  Cut To Length machines
    Min Length
      By Gauge Range
    Speed (Feet per minute)
      By Gauge Range & Length range
    Stack Change Time
      By Length
    Max Bundle LBS
      By Length
    Setup Time
      By Gauge Range
  Blanking Machines
    Speed (Feet per minute)
      By Gauge & Number of cuts
    Max # of blanks
      By Gauge & Yield Strength
    Max Thickness
      By Yield Strength & Width
  Slitting Machines
    Inches of Penetration
      By Gauge & Yield Strength
    Min Width
      By Gauge & Yield Strength
    Tooling
      By Gauge, Width & Yield Strength
    Inches of Penetration by OD
      By Gauge & Width
    Line Speed
      By Gauge & Number of cuts
    Prep Time
      By Gauge & Number of cuts
    Coil Change over Time
      By Gauge & Number of cuts
    Break by weight time
      By Gauge & Number of cuts
    Re-pass minutes
Packaging Costs
  Skid
    Define boards needed to build skids
    Cost per board foot
  Bands
  Paper
  Seals
  Edge protectors
  Spacers/Doughnuts
Expense inputs
  Used to calculate labor rate per hour
  Fixed vs. variable allocations
```

TABLE 3
Variables related to the Client

```
Part #
Usage Details
Product Type
Dimensions
  Width/Length/Thickness
Grade
  Yield Strengths
  Coating/surface treatments
```

### System Description

Regarding the methods disclosed, the method may be embodied as a computer-based method to minimize the cost of a raw material (for example steel) used by a manufacturer in the supply chain. The method includes: maintaining data in a memory, computing, based on at least the data one or more optimal specifications for minimizing the cost of a raw material used by a manufacturer in the supply chain, such as by determining the optimal dimensions (such as length and/or width) of a stock of the raw material; optionally computing using the data and the one or more optimal specifications, variables concerning the vendor/production mill from which the raw material conforming to the optimal specification(s) is purchased, variables concerning the third party service provider that purchases and/or further process the raw material purchased from the vendor/production mill and variables relating to the client, an additional analysis to validate the one or more optimal specifications, wherein the additional analysis may be i) a risk analysis to identify the potential impact of a change in usage or a particular part or group of parts; ii) a stress testing analysis to simulate the impact of a change in usage or a particular part or group of parts; and/or iii) a cost model analysis to identify factors that impact the cost of the raw materials specified in the one or more optimal specifications; optionally modifying the one or more optimal specifications if the results of the additional analysis indicate that the one or more optimal specifications are subject to volatility as a result in a shift in usage or that the raw material specified in the one or more optimal specifications is not cost effective by repeating the above instructions.

The data referred to above may be any data disclosed herein. In one embodiment, the data includes, but is not limited to, information about the parts to be manufactured, information regarding the manner in which the parts are produced, information regarding the steel currently used in the manufacturing process, information concerning the equipment to be used by the client to manufacture the parts, data concerning the vendor/production mill, data concerning the third party service provider and data relating to the client.

The invention may further be embodied as a computerized system having an input interface means, a means for processing, a means for storing, and an output interface means. The input interface means is for receiving data that includes data concerning the vendor/production mill, data concerning the third party service provider and data relating to the client. The means for processing is operatively connected to the input interface means. The means for storing is for storing the data and instructions. The instructions when executed by the processing means cause the processing means to: compute, based on at least the data relating to the client maintained in the memory, one or more optimal specifications for minimizing the cost of a raw material used by a manufacturer in the supply chain, such as by determining the optimal dimensions (such as length and/or width) of a stock of the raw material; optionally compute, based on the one or more optimal specifications, variables concerning the vendor/production mill from which the raw material conforming to the optimal specification(s) is purchased, variables concerning the third party service provider that purchases and/or further process the raw material purchased from the vendor/production mill and variables relating to the client, an additional analysis to validate the one or more optimal specifications, wherein the additional analysis may be i) a risk analysis to identify the potential impact of a change in usage or a particular part or group of parts; ii) a stress testing analysis to simulate the impact of a change in usage or a particular part or group of parts; and/or iii) a cost model analysis to identify factors that impact the cost of the raw materials specified in the one or more optimal specifications; optionally modify the one or more optimal specifications if the results of the additional analysis indicate that the one or more optimal specifications are subject to volatility as a result in a shift in usage or that the raw material specified in the one or more optimal specifications is not cost effective by repeating the above instructions.

The method may additionally be embodied as a machine readable storage medium containing instructions associated with minimizing the cost of a raw material (for example steel) used by a manufacturer in the supply chain. The instructions when executed cause the following: compute, based on at least the data relating to the client maintained in the memory, one or more optimal specifications for minimizing the cost of a raw material used by a manufacturer in the supply chain, such as by determining the optimal dimensions (such as length and/or width) of a stock of the raw material; optionally compute, based on the one or more optimal specifications, variables concerning the vendor/production mill from which the raw material conforming to the optimal specification(s) is purchased, variables concerning the third party service provider that purchases and/or further process the raw material purchased from the vendor/production mill and variables relating to the client, an additional analysis to validate the one or more optimal specifications, wherein the additional analysis may be i) a risk analysis to identify the potential impact of a change in usage or a particular part or group of parts; ii) a stress testing analysis to simulate the impact of a change in usage or a particular part or group of parts; and/or iii) a cost model analysis to identify factors that impact the cost of the raw materials specified in the one or more optimal specifications; optionally modify the one or more optimal specifications if the results of the additional analysis indicate that the one or more optimal specifications are subject to volatility as a result in a shift in usage or that the raw material specified in the one or more optimal specifications is not cost effective by repeating the above instructions.

In one embodiment, the computerized system for implementing the methods disclosed includes a processing unit, a storage unit, an input module, and an output module. In certain embodiment, the various components may be separate or may be integrated. In one embodiment, these components are part of a personal computer. In an alternate embodiment, these components may be part of a workstation or a part of a computer network.

The input module is configured to input and/or receive data that includes data concerning the vendor/production mill, data concerning the third party service provider and data relating to the client, and the data is stored in the storage unit. The input module may for example include a USB socket or other drive for reading a storage medium of a personal computer. The input module may alternatively receive input from an entry device, such as a keyboard, and/or an additional computer system, such as through a network.

The output module is configured to transmit the results of the analysis to an end user. The output module may for example include a display for the user to visually observe the output. The output module may include a printer or a storage medium.

The processing unit is operatively connected to at least one of the input module, the output module, and the storage unit. The processing unit executes instructions which may be contained in the processing unit, the storage unit or another location. The instructions, when executed, cause the processing unit to: compute, based on at least the data relating to the client maintained in the memory, one or more optimal specifications for minimizing the cost of a raw material used by a manufacturer in the supply chain, such as by determining the optimal dimensions (such as length and/or width) of a stock of the raw material; optionally compute, based on the one or more optimal specifications, variables concerning the vendor/production mill from which the raw material conforming to the optimal specification(s) is purchased, variables concerning the third party service provider that purchases and/or further process the raw material purchased from the vendor/production mill and variables relating to the client, an additional analysis to validate the one or more optimal specifications, wherein the additional analysis may be i) a risk analysis to identify the potential impact of a change in usage or a particular part or group of parts; ii) a stress testing analysis to simulate the impact of a change in usage or a particular part or group of parts; and/or iii) a cost model analysis to identify factors that impact the cost of the raw materials specified in the one or more optimal specifications; optionally modify the one or more optimal specifications if the results of the additional analysis indicate that the one or more optimal specifications are subject to volatility as a result in a shift in usage or that the raw material specified in the one or more optimal specifications is not cost effective by repeating the above instructions.

As non-limiting examples, the processing unit of system may include a standard computer processor, for example, an Intel Core i7-3770K, an AMD A10-5700, an Intel Xeon E5-2687W, or any other equivalent means for processing (executing) instructions contained in the storage unit. Also as non-limiting examples, the storage unit may be SATA hard drive, a flash memory SSD, or any other equivalent means for storing instructions that when executed by the processing unit cause the processing unit to function as described above.

A user may interact with the system through a network. As non-limiting examples, the network may be a local area network (LAN) within an office environment or alternatively the Internet. An alternative embodiment may implement a “hosted” architecture for the computing module, whereby the algorithmic calculations are done in a remote data-center (server farm) accessible over the network/Internet. Another alternative embodiment may implement a cloud computing configuration for the computing module. Thus, a user may interact with the system using a Windows-based utility or a web browser, as non-limiting examples.

### EXAMPLES

The methods of the present disclosure were simulated on an actual commercial usage pattern. The stock currently used in the manufacturing process included 3 steel sheets of the following dimensions: i) 48×54; ii) 48×120; and iii) 60×72 (dimensions in inches). In this example, 124 parts were specified. A usage rate for each part was also specified as well as the particular stock piece used in the current manufacturing process. Other information as described above, such as the part dimensions, was also used. The above information, as well as other data specified above was input into a database. Table 4 provides a description of the data regarding the current manufacturing process, providing only a portion of the data for illustrative purposes.

The data was initially analyzed by plotting the various parts to be manufactured. FIG. 1, described above, provides an exemplary embodiment of such an analysis. The X-axis lists parts numbers, in this case from 1 to 124. The Y-axis provides total pounds for each part (right side) and lengths and/or width (in inches, left side). The dots positioned vertically above each part represent potential optimal solutions in terms of length and/or width (the color of the dots in FIG. 1 is arbitrary) while the bars represent the usage in pounds for each part. The plot report provides a visual representation of the parts to be manufactured in terms of pounds of steel required for each part and also in terms of potential lengths and width of the steel stock that may be used to produce each part. The data in FIG. 1 show that in general larger lengths of steel stock, for example from 60 to 120 inches, may be preferred for certain pieces while for other parts steel stock having a length less than 60 inches may be preferred. Furthermore, the data show that the for certain parts (those with dots spanning both ranges more or less equally, either solution may be valid.

Table 4 provides representative information regarding the parts to be manufactured using the current manufacturing process.

TABLE 4
Overall Scrap Rate- 35.83%

| | With | Length | Usage | Usage | | Static | Nested |
|---|---|---|---|---|---|---|---|
| Part | (inches) | (inches) | (per part) | (pounds) | Stock Size | Scrap | Scrap |
| 1 | 3.5843 | 76.8750 | 21 | 132 | 48 × 84 | 33.86% | 7.00% |
| 2 | 4.8734 | 76.8750 | 21 | 167 | 48 × 84 | 34.96% | 12.46% |
| 3 | 5.8734 | 76.8750 | 21 | 202 | 48 × 84 | 21.61% | 12.46% |
| 4 | 6.2801 | 76.8750 | 21 | 216 | 48 × 84 | 28.16% | 6.94% |
| 5 | 31.1648 | 38.5529 | 21 | 537 | 48 × 84 | 40.40% | 33.41% |
| 6 | 4.8117 | 24.6875 | 70 | 177 | 48 × 84 | 29.29% | 7.96% |
| 7 | 10.2497 | 80.2000 | 75 | 1,311 | 48 × 84 | 18.45% | 2.20% |
| 8 | 13.4933 | 80.2000 | 91 | 2,095 | 48 × 84 | 19.48% | 3.37% |
| 9 | 1.9786 | 12.0000 | 114 | 58 | 48 × 84 | 27.57% | 17.94% |
| 10 | 6.3600 | 13.0000 | 66 | 116 | 48 × 84 | 26.18 | 11.02 |

As stated above, the current manufacturing process specified 3 sizes of steel stock: i) 48×54; ii) 48×120; and iii) 60×72 (dimensions in inches). Under the current manufacturing processes, the scrap rate was determined to be 35.83%. This value was determined to be the baseline scrap percentage. An optimization step as described herein was performed. The optimization step generated several optimal specifications, two of which are described below for exemplification. One optimal specification retained the 3 steel stock size option (referred to as Optimal Specification 1) and one optimal specification reduced the number of steel stock sizes from 3 to 2 (Optimal Specification 2). In this example, the optimization step was carried out using the multi-sheet option based on the largest pounds used or largest area option.

Optimal Specification 1 specified the following dimensions for the steel stock sizes: i) 38.75×106.88; ii) 49.02×84.5; and iii) 51.3×120. In this iteration, the maximum width was set at 60 inches. Mill constraints dictated that the length of 51.3 inches carried an increase in the costs of the specified stock due to a width over 50 inches (an increase in $1.50/CWT). The cost model identified the increase. Re-running the optimization, using a maximum width of 50 inches specified by the mill constrains, resulted in the following dimensions for the steel stock sizes for Optimal Specification 1: i) 38.75×106.88; ii) 49.02×84.5; and iii) 49.02×120. The increase in scrap rate between this specification and the original specification was 0.25%. While higher by a small amount, the increase in scrap rate did not negate the $1.50/CWT price savings achieved using a sheet having a width of 49.02 inches. As a result, the 51.3 inch width dimension was discarded and the 49.02 inch width dimension was used. The use of the same length dimension of 49.02 also simplifies the supply chain as well. The overall scrap rate for Optimal Specification 1 was calculated to be 25.89, a significant decrease over the baseline scrap rate of 35.83%.

Optimal Specification 2 specified the following dimensions for the steel stock sizes: i) 49.02×84.5; and ii) 47.12×120. The overall scrap rate for Optimal Specification 2 was calculated to be 30.18%. While higher than the scrap rate for Optimal Specification 1, the scrap rate for Optimal Specification 2 also showed a significant decrease over the baseline scrap rate of 35.83%.

Optimal Specifications 1 and 2 were further evaluated by subjecting the results to a risk analysis. In this example, a scrap rate for each part manufactured using the generated optimal specifications was determined, a scrap rate for each part manufactured under the current manufacturing process was determined and the scrap rate for each part manufactured using the generated optimal specifications was compared to the scrap rate for each part manufactured under the current manufacturing process. The results allow the identification one or more parts that have a positive, negative or neutral scrap rates as compared to the current manufacturing process. By identifying parts with a negative scrap rate, the identified parts can be monitored for increase in use as compared to the usage value used to generate the optimal specifications.

The results presented in FIGS. 2A and 2B as described above. FIG. 2A shows the results from a comparison of an exemplary current manufacturing process utilizing 3 different sizes of stock to Optimal Specification 1 specifying the same number of stock sizes but altering the dimensions and FIG. 2B shows the results from a comparison of an exemplary current manufacturing process utilizing 3 different sizes of stock to Optimal Specification 2 specifying 2 sizes of stock. As can be seen in FIGS. 2A and 2B, a greater majority of parts exhibit a positive scrap rate. Furthermore, the magnitude of the positive scrap rate variance is in most cases greater than the negative scrap rate variance. This indicates that the odds of a random swing in usage will not likely impact the utility of the optimal specification. Furthermore, a comparison of FIGS. 2A and 2B indicate that simplifying the supply chain from 3 stock sizes to 2 stock sizes will not significantly impact the risk analysis.

Optimal Specifications 1 and 2 were further evaluated by subjecting the results to a stress analysis. In this example, the usage rate for a given part was varied from the actual usage rate to create a simulated usage range (with the remainder of the parts being held at the actual usage rate), 1000 values within the simulated usage range were randomly selected, and the scrap rate under the generated optimal specification using each of the plurality of values within the simulated usage range was determined to generate a simulated scrap rate. The process was repeated for each part and the results were aggregated to provide an average simulated scrap rate. The process was also carried out with the current manufacturing conditions using the same values from the simulated usage range. The calculations were carried out using a Monte Carlo simulation.

The results are shown in FIGS. 3A to 3C. In these figures, the X axis represents the scrap rate of each simulation and the Y axis represents the percentage of the scenarios that resulted in a given scrap rate. In these figures, data from all parts has been aggregated. FIG. 3A shows the results from the current manufacturing process utilizing 3 different sizes of stock, FIG. 3B shows the results using Optimal Specification 1 keeping the number of stock sizes the same but changing the dimensions of the stock sizes and FIG. 3C shows the results using Optimal Specification 2 where the number of stock sizes was decreased to 2. As can be seen in comparison of FIGS. 3A and 3B/3C the proposed optimal specification results in a significant decrease in overall scrap rate. For FIG. 3A, the average scrap rate was 34.52% (standard deviation of 0.0062, with a minimum and maximum scrap rate of 32.56% and 36.17% respectively). For FIG. 3B, the average scrap rate was 24.4% (standard deviation of 0.0033, with a minimum and maximum scrap rate of 23.41% and 25.42% respectively). For FIG. 3C, the average scrap rate was 29.51% (standard deviation of 0.0057, with a minimum and maximum scrap rate of 27.79% and 31.15% respectively). As shown in FIGS. 3B and 3C, the simulated change in usage does not significantly change the scrap rate determined under actual usage conditions.

Optimal Specifications 1 and 2 were further evaluated by subjecting the results to a cost analysis. A number of potential optimal specifications were generated during the optimization process described above. As an example of the cost analysis procedure, an alternate optimal specification to both the preferred Optimal Specifications 1 and 2 is provided.

Table 7 shows the cost analysis of Optimal Specification 1 and an alternate optimal specification specifying three stock sizes with different dimensions. As can be seen in Table 7, although the alternate optimal specification utilizes dimensions that are similar to Optimal Specification 1, the dimensions specified by Optimal Specification 1 result in a lower costs. The total annual spend for Optimal Specification 1 was calculated to be $560,119, with the total annual spend under the alternate optimal solution calculated to be $578,587. The scrap rates observed between the 2 generated optimal specifications was minimal

TABLE 7

| | | | | | | | | | |
|---|---|---|---|---|---|---|---|---|---|
| | | | | | | | | | Annual |
| Sheet | Material | Gauge | Width | Length | Lbs/sheet | #/year | Price/CWT | Price/Sheet | Spend |

Optimal Specification 1

| | | | | | | | | | |
|---|---|---|---|---|---|---|---|---|---|
| 1 | A1011 | 0.071 | 49.02 | 84.5 | 90.2 | 3,816 | $40.55 | $36.58 | $139,605 |
| | CS Type | | | | | | | | |
| | B* | | | | | | | | |
| 2 | A1011 | 0.071 | 49.02 | 120.0 | 128.1 | 5,412 | $40.54 | $51.94 | $281,098 |
| | CS Type | | | | | | | | |
| | B* | | | | | | | | |
| 3 | A1011 | 0.071 | 38.75 | 106.88 | 90.2 | 3,792 | $40.76 | $36.77 | 139,415 |
| | CS Type | | | | | | | | |
| | B* | | | | | | | | |
| | | | | | | | | | $560,119 |

Alternate Optimal Specification

| | | | | | | | | | |
|---|---|---|---|---|---|---|---|---|---|
| 1 | A1011 | 0.071 | 48.0 | 120 | 125.5 | 5,832 | $40.42 | $50.71 | $295,741 |
| | CS Type | | | | | | | | |
| | B* | | | | | | | | |
| 2 | A1011 | 0.071 | 48.0 | 84.0 | 87.9 | 4,392 | $40.39 | $35.74 | $155,784 |
| | CS Type | | | | | | | | |
| | B* | | | | | | | | |
| 3 | A1011 | 0.071 | 38.75 | 106.88 | 90.2 | 3,456 | $40.76 | $36.77 | $127,062 |
| | CS Type | | | | | | | | |
| | B* | | | | | | | | |
| | | | | | | | | | $578,587 |

*pickled and oiled

A similar analysis was carried out for Optimal Specification 2. The total annual spend for Optimal Specification 2 was calculated to be $594,461.

The total annual spend for the current manufacturing process, modified to specify two stock sheets of 48.0×120 and 48.0×84, was calculated to be $642,391. The use of Optimal Specification 1 resulted in a cost saving of over 12% in annualized spending as compared to the current process. Optimal Specification 2 resulted in a cost savings of over 7% in annualized spending as compared to the current process. As the scrap rate was lower for Optimal Specification 1, as well as the annualized cost, Optimal Specification 1 provides the best solution to the client.

In order to further illustrate the benefits of the present method, specific examples of the decrease in scrap rate realized using Optimal Specification 1 is provided. In the first example, a part having dimensions of 4.5×80.87 inches was cut from a 48×84 inch stock piece under the current manufacturing conditions. Use of the 48×84 inch stock sheet allowed 9 parts to be cut from the single stock sheet. Using the dimensions specified by Optimal Specification 1, 49.02×84.5, 10 parts could cut from the single stock sheet. In the second example, a part having dimensions of 3.4997×25.5 inches was cut from a 48×84 inch stock piece under the current manufacturing conditions. Use of the 48×84 inch stock sheet allowed 30 parts to be cut from the single stock sheet. Using the dimensions specified by Optimal Specification 1, 49.02×84.5, 33 parts could cut from the single stock sheet. As can be seen from these illustrations, an increase in the length dimension of just over 1 inch and an increase in the length dimension by 1.5 inches allowed the maximum utilization of the stock sheet by the client, thereby reducing the scrap and costs to the client.

What is claimed:

1. A method for optimization of a supply chain, the method comprising the steps of
a. performing a data analysis on a data set to determine a parameter about the raw material; and
b. performing an optimization based on the data analysis to generate one or more optimal specifications for the raw material.

2. The method of claim 1, wherein the method further comprises at least one of the following:
a. a data gathering step;
b. establishment of a baseline usage rate;
c. a risk analysis; a stress simulation; and
d. a cost optimization.

3. The method of claim 1, wherein the optimization comprises providing the optimal specifications for the raw material consumed in the supply chain.

4. The method of claim 1, wherein the optimization comprises identifying an optimal vendor for provision of the raw material consumed in the supply chain.

5. The method of claim 1, wherein the optimization comprises minimizing the number of different forms of the raw material required

6. The method of claim 1, wherein the optimization minimizes the costs of obtaining a raw material in a supply chain.

7. The method of claim 3, wherein the cost is minimized by reducing the scrap of the raw material resulting from the manufacturing process.

8. The method of claim 3, wherein the cost is minimized by reducing a factor unrelated to reducing the scrap of the raw material resulting from the manufacturing process.

9. The method of claim 1, wherein the data set includes at least one of the following: (i) information about the parts to be manufactured; (ii) information regarding the manner in which the parts are produced; (iii) information regarding the raw material currently used in the manufacturing process; and (iv) information concerning the equipment to be used by the client to manufacture the parts.

10. The method of claim 9, wherein information about the parts to be manufactured includes at least one of the following: (i) the scrap rate; (ii) the dimensions of each part to be manufactured; (iii) the number of each part to be manufactured; (iv) the weight of each part to be manufactured; (v) required spacing between various parts; (vi) current mapping of the parts onto steel sheet or coil; (vii) whether rotation of a part is allowed; and (viii) whether any two parts may share a common cut line.

11. The method of claim 9, wherein information about the manner in which the parts are produced includes at least one of the following: (i) whether the parts are stamped from the raw material stock and (ii) or whether the parts are cut from the raw material stock.

12. The method of claim 9, wherein information about the raw material currently used in the manufacturing process includes at least one of the following: (i) pricing of the raw material; (ii) the form of the raw material used; (iii) the dimensions of the raw material; (iv), coatings or other treatments required; (v) the number of stock forms currently used; and (vi) other physical properties of the raw material.

13. The method of claim 9, wherein information about the equipment to be used by the client to manufacture the parts includes at least one of the following: (i) the maximum dimensions of the stock the equipment can utilize; (ii) the minimum dimensions of the stock the equipment can utilize; and (iii) the amount of trim distance required.

14. The method of claim 1, wherein the data analysis generates a report that shows a pattern of usage of the parts to be manufactured from the raw material, generates a series of preferred widths, lengths or a combination of the foregoing of raw material that are candidates for the production of each part based on the dimensions of the part.

15. The method of claim 1, wherein the data analysis generates a baseline scrap rate.

16. The method of claim 1, wherein the raw material is steel.

17. The method of claim 1, wherein the method further comprises performing a risk analysis on the generated optimal specification.

18. The method of claim 17, wherein the risk analysis compares the generated optimal specification versus the current manufacturing process to assess the risk associated in a shift in usage of one or more parts.

19. The method of claim 17, wherein the risk analysis comprises determining a scrap rate for each part manufactured using the generated optimal specification, determining the scrap rate for each part manufactured under the current manufacturing process and comparing the scrap rate for each part manufactured using the generated optimal specification to the scrap rate for each part manufactured under the current manufacturing process to identify one or more parts that have a positive, negative or neutral scrap rates as compared to the current manufacturing process.

20. The method of claim 1, wherein the method further comprises performing a stress test on the generated optimal specification.

21. The method of claim 20, wherein the stress test compares the generated optimal specification versus the current manufacturing process to assess the risk associated in a shift in usage of one or more parts.

22. The method of claim 20, wherein the stress test comprises varying the usage rate for a given part from the actual usage rate to create a simulated usage range, selecting a plurality of values within the simulated usage range, evaluating the scrap rate under the generated optimal specification using each of the plurality of values within the simulated usage range to generate a simulated scrap rate and comparing the simulated scrap rate to the scrap rate generated from the actual usage rate using the optimal specification.

23. The method of claim 22, wherein the comparison scrap rate is determined for a single part or more than one part.

24. The method of claim 22, wherein the comparison scrap rate is an aggregate of all parts to be manufactured.

25. The method of claim 22, wherein the optimal specification is valid if the comparison scrap rate is within a defined percentage of the scrap rate generated from the actual usage rate using the optimal specification.

26. The method of claim 22, wherein the results are obtained using a Monte Carlo simulation.

27. The method of claim 1, wherein the method further comprises performing a cost analysis on the generated optimal specification.

28. The method of claim 27, wherein the cost analysis compares one or more of the generated optimal specification to a database of cost factors to determine which of the generated optimal specifications results in the lowest costs.

29. The method of claim 28, wherein the cost analysis comprises inputting a first generated optimal specification into a database of cost factors to determine a first cost, inputting a second additional generated optimal specification into the database of cost factors to determine at a second cost and optionally inputting an n^{th} additional generated optimal specification into the database of costs factors to determine an n^{th} cost.

30. The method of claim 29, further comprising comparing the first cost to the second cost and optionally the n^{th} costs to identify the generated optimal specification with the lowest overall costs.

31. The method of claim 29, wherein the cost factors comprise: (i) variables concerning the vendor from which the raw material conforming to a generated optimal specification is purchased; (ii) variables concerning the third party service provider that further process the raw material purchased from the vendor; and (iii) variables relating to the client.
